(19) United States
(12) Patent Application Publication
(10) Pub. No.: US 2006/0149961 A1
(43) Pub. Date: Jul. 6, 2006

(54) Contents player and playing method, mobile code providing device and providing method applied to DRM system

(75) Inventors: Sang-do Park, Seoul (KR); Moon-jeong Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/304,597

(22) Filed: Dec. 16, 2005

(30) Foreign Application Priority Data
Jan. 6, 2005 (KR) 2005-1145

(51) Int. Cl. H04L 9/00

(52) U.S. Cl. 713/150; 705/59

(57) ABSTRACT

A contents player, a method for playing contents, a mobile code providing device and a method for providing a mobile code, that are applied to a digital rights management (DRM) system. The contents player applied to the DRM system, according to an embodiment of the present invention, includes a network interface part which receives the contents and additional data regarding the contents; a DRM module management part which demodulates the contents by a predetermined DRM module and if the DRM module capable of demodulating the contents does not exist, updates the DRM module through the network interface part; and a contents playing part which plays the demodulated contents. Accordingly, all the contents provided by a content provider can be used regardless of the DRM technology applied to the contents and a platform of a demodulator.

### CROSS-REFERENCE TO RELATED APPLICATIONS

This application claims priority from Korean Patent Application No. 10-2005-01145, filed Jan. 6, 2005, the entire disclosure of which is incorporated herein by reference.

### BACKGROUND OF THE INVENTION

1. Field of the Invention

Apparatuses and methods consistent with the present invention generally relate to a contents player, a method for playing the contents, a mobile code provider, and a method for providing the mobile code, which are applied in a DRM system and capable of coping with a variety of digital rights management (DRM) technologies regardless of a contents demodulator.

2. Description of the Related Art

DRM seeks to continuously manage and protect intellectual assets of digital contents using encryption technology. In other words, the DRM delivers various contents on the network from a content provider (CP) to a user and prohibits illegal distribution of the contents by the user.

For this purpose, the DRM system not only protects the contents and copyright of the contents but also controls processes required for generation, distribution, usage and management of the contents. Furthermore, the DRM system restrains any unauthorized user from accessing and using the contents.

FIGS. 1A and 1B illustrate a general DRM system.

Referring to FIG. 1A, the DRM system includes a CP 10 that provides contents, a license server 20 that provides a license, and a user terminal device 30 that enables use of the contents provided by the CP 10.

The CP 10 provides contents required by the user and meta data regarding the contents. The meta data refers to data for explaining the data. Therefore, the meta data contents includes expatiation on the contents.

Upon request for a license from the user terminal device 30, the license server 20 provides the user terminal device 30 with the license. Here, the license refers to data defining a demodulation key for demodulating encrypted contents and the use right for the contents (such as the number of times and expiration time of use).

The user terminal device 30 comprises a meta data interpretation part 32 analyzing the meta data received from the CP 10, a DRM control part 34 controlling the DRM, and an application part 36 playing the contents.

The DRM system as shown in FIG. 1A comprises one CP 10 and one license server 20, and the CP 10 and the license server 20 use the same DRM technology. In this case, as long as the meta data interpretation part 32 and the DRM control part 34 have information on one DRM technology, a problem does not arise.

However, when the CP 10 and the license server 20 uses different types of DRM technologies, the user terminal device 30 is required to have information on the two different DRM technologies in order to interpret the data provided from the CP 10 and the license server 20.

The DRM system may comprise a plurality of CPs 10 and a plurality of license servers 20. This may not cause any special problem if the plurality of CPs 10 all use the same DRM technology. However, it is rare that the plurality of CPs 10 use the same DRM technology.

Referring to FIG. 1B, the user terminal device 30 may comprise a personal computer (PC) 30a and a personal digital assistant (PDA) 30b. In this case, the PC 30a uses a Window-based contents player while the PDA 30b uses a Linux-based contents player. When the contents provided from the CP 10 is Window-based contents, that is, when there is no DRM for playing the Linux, the PDA 30b cannot play the contents.

As described above, since the digital contents and service to be provided for users usually require different types of DRM technologies according to a media type, interoperability in processing information on use, processing and transaction of the digital contents and compatibility are very low. Also, management of such a variety of DRM technologies demands high cost.

### SUMMARY OF THE INVENTION

An aspect of the present invention is to provide a contents player and a playing method, a mobile code providing device and a providing method, which are all applied in a DRM system and dynamically expanding the DRM technology in order to play contents encrypted by different types of the DRM technologies according to a media type, in devices having different platforms.

According to an aspect of the present invention, there is provided a contents player applied to a DRM system, comprising a network interface part receiving the contents and additional data regarding the contents; a DRM module management part demodulating the contents by a predetermined DRM module and when the DRM module capable of demodulating the contents does not exist, updating the DRM module through the network interface part; and a contents playing part playing the demodulated contents.

The additional data comprises meta data of the contents and meta data interpretation module information. The meta data interpretation module information includes a uniform resource identifier (URI) capable of receiving the DRM module.

The contents player may further comprise a meta data interpretation part for analyzing the meta data by the predetermined meta data interpretation module. When the meta data interpretation module corresponding to the meta data does not exist, the meta data interpretation part updates the meta data interpretation module through the network interface part.

The meta data interpretation module may be provided in the form of a Java-based mobile code. The DRM module may be provided in the form of a Java-based mobile code. The contents providing server comprises a DRM module database storing at least one DRM module.

According to another aspect of the present invention, there is provided a method for playing contents, applied to a DRM system, the method comprising receiving contents encrypted by a DRM technology from a contents providing server and additional data regarding the contents; demodulating the received contents by a predetermined DRM module; when the DRM module capable of demodulating the contents does not exist in the demodulating operation, updating the DRM module and demodulating the contents by the updated DRM module; and playing the demodulated contents.

The additional data comprises meta data of the contents and meta data interpretation module. The meta data interpretation module includes a URI capable of receiving the DRM module.

The method may further comprise analyzing the meta data by the predetermined meta data interpretation module. When the meta data interpretation module corresponding to the meta data does not exist, further comprising updating the meta data interpretation module.

The meta data interpretation module may be provided in the form of a Java-based mobile code. The DRM module may be provided in the form of a Java-based mobile code.

According to a yet another aspect of the present invention, there is provided a mobile code providing device comprising a network interface part receiving a predetermined mobile code requesting signal from a contents player; a mobile code request processing part extracting mobile codes of a DRM module and a meta data interpretation module from a database based on the received requesting signal; and a mobile code transmission part transmitting the extracted mobile codes of the DRM module and the meta data interpretation module to the contents player.

The database comprises a DRM module database storing the mobile code of the DRM module and a meta data interpretation module database storing the mobile code of the meta data interpretation module.

According to a still another aspect of the present invention, there is provided a method for providing a mobile code in a mobile code providing device which provides a predetermined mobile code to a contents player, the method comprising receiving a predetermined mobile code requesting signal from the contents player; and extracting mobile codes based on the received requesting signal and transmitting the extracted mobile codes to the contents player.

The method may further comprise, after receiving the mobile code requesting signal, transmitting an error message to the contents player when the mobile code does not exist.

### BRIEF DESCRIPTION OF THE DRAWINGS

The above and/or aspects of the present invention will become more apparent by describing in detail exemplary embodiments thereof with reference to the attached drawing figures, wherein;

FIGS. 1A and 1B show a conventional DRM system;

FIG. 2 shows the structure of a network in a DRM system according to an exemplary embodiment of the present invention;

FIG. 3 is a block diagram of a contents player according to an exemplary embodiment of the present invention;

FIG. 4 is a flowchart for explaining a method for playing the contents, according to an exemplary embodiment of the present invention;

FIG. 5 is a block diagram of a mobile code providing device applied to the DRM system;

FIG. 6 is a flowchart for explaining a method for providing the mobile code, according to an exemplary embodiment of the present invention; and

FIG. 7 is a flowchart for explaining flow of signals in the DRM system.

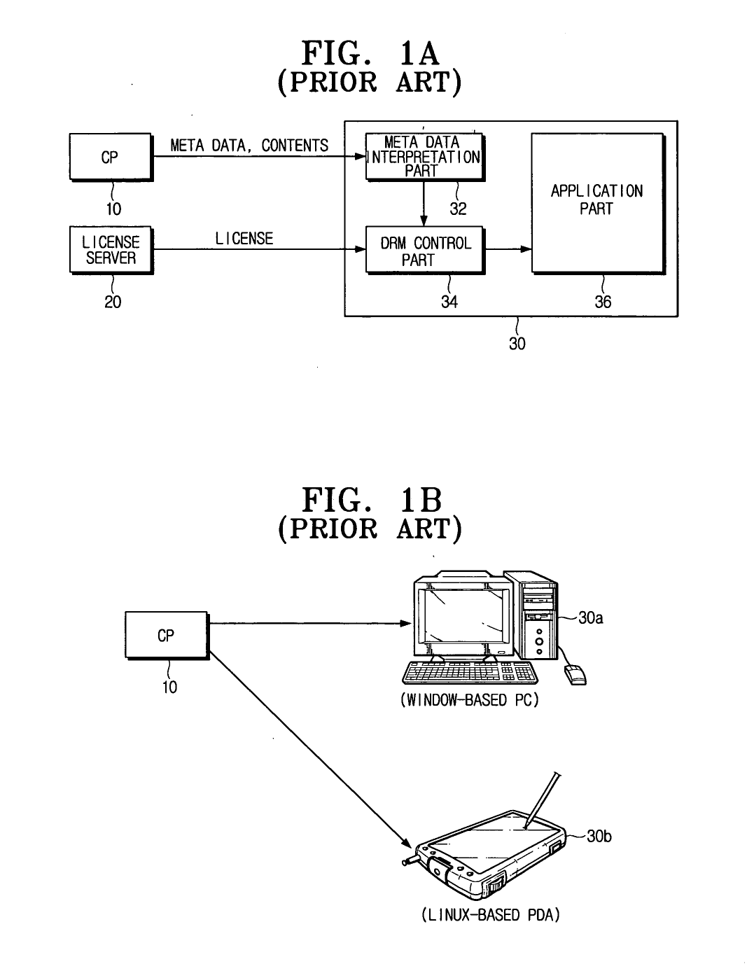

### DETAILED DESCRIPTION OF THE EXEMPLARY EMBODIMENTS

Hereinafter, certain exemplary embodiments of the present invention will be described in detail with reference to the accompanying drawing figures.

In the following description, the matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

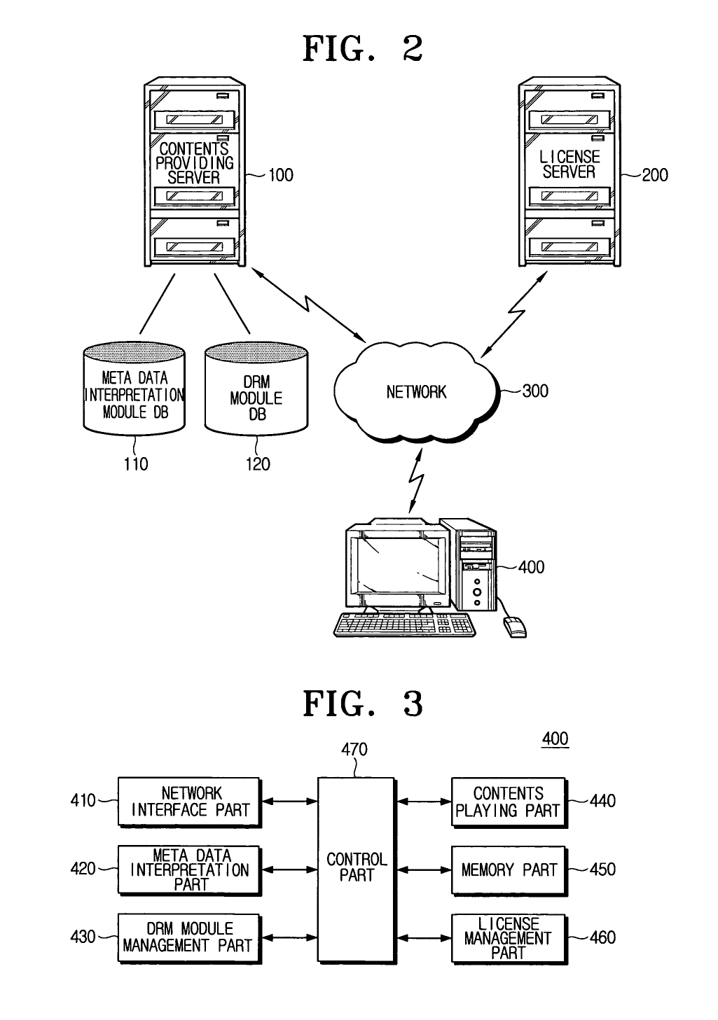

FIG. 2 is a structure view of a network in a DRM system according to an exemplary embodiment of the present invention.

Referring to FIG. 2, the DRM system according to an exemplary embodiment of the present invention, comprises a contents providing server 100, a license server 200, and a contents player 400 interconnected through a network 300.

The contents providing server 100, upon request for predetermined contents by a user through the network 300, provides the contents and additional data encrypted using the DRM technology in a manner of streaming or downloading.

The contents providing server 100 according to this exemplary embodiment comprises a meta-data interpretation module database 110 and a DRM module database 120. The meta-data interpretation module database 110 stores at least one meta-data interpretation module for supply to the contents player 400 which will be described hereinafter. The DRM module database 120 stores a DRM module.

The meta-data interpretation module and the DRM module, herein, may apply a Java-based mobile code or other forms of mobile codes.

The additional data provided together with the contents may comprise the meta data which includes expatiation on the contents and meta-data interpretation module information preparing for absence of the meta-data interpretation module for interpreting the meta data.

The meta-data interpretation information may include a uniform resource identifier (URI) for being provided with the meta-data interpretation module and the DRM module which will be described hereinafter. The URI included in the meta-data interpretation information may be a URI for the contents providing server 100 or a URI for an independent server having a database regarding the meta-data interpretation module and the DRM module.

The license server 200 is provided with a function of identifying a license of the user and is also called a “Clearing house”. In the DRM system, the license server 200 is indispensable when the contents provided by the contents providing server 100 and the licenses are separately distributed.

The contents player 400 requests predetermined contents of the contents providing server 100 through the network 300, ensures the right to use the contents by being provided with the license from the license server 200, and demodulates and plays the contents which are encrypted by the DRM technology. The contents player 400 will be described in greater detail with reference to FIG. 3 hereinafter.

FIG. 3 is a block diagram of a contents player according to an exemplary embodiment of the present invention.

The contents player 400 according to an exemplary embodiment of the present invention comprises a network interface part 410, a meta-data interpretation part 420, a DRM module management part 430, a contents playing part 440, a memory part 450, a license management part 460, and a control part 470.

The network interface part 410 interfaces between the contents player 400, the contents providing server 100 and the license server 200 through the network 300. The contents player 400 requests the contents of the contents providing server 100 through the network interface part 410 and receives the requested contents and additional data regarding the requested contents. In addition, the contents player 400 may request the license of the license server 200 through the network interface part 410 and receive the requested license.

The meta data interpretation part 420 interprets the meta data provided by the contents providing server 100. Before interpreting the meta data, the meta data interpretation part 420 may analyze the meta data interpretation module information provided from the contents providing server 100 in order to determine whether the meta data can be interpreted by a current meta data interpretation module.

The meta data interpretation part 420 analyzes the meta data interpretation module information. When it is determined that there is no meta data interpretation module corresponding to the meta data, the meta data interpretation part 420 updates the meta data interpretation module by being provided with the meta data interpretation module in the form of a mobile code by the contents providing server 400 through the network interface part 410. The type of the DRM technology applied to the contents can be known through the meta data.

The DRM module management part 436 demodulates the contents provided from the contents providing server 100 by a predetermined DRM module. When there is no DRM module capable of demodulating the contents, the DRM module management part 430 updates the DRM module by being provided with the DRM module in the mobile code form from the contents providing server 100 through the network interface part 410.

The contents playing part 440 plays the contents demodulated by the DRM module management part 430 to provide them for the user.

The memory part 450 stores the mobile codes of the meta data interpretation module and the DRM module each time of updating the meta data interpretation module and the DRM module by the meta data interpretation part 420 and the DRM module management part 430. Therefore, the updated meta data interpretation module and the DRM module can be reused later.

The license management part 460 requests the license of the license server 200 through the network interface part 410 in order to ensure the right to use the contents.

The control part 470 conducts the overall functions of the network interface part 410, the meta data interpretation part 420, the DRM module management part 430, the contents playing part 440, the memory part 450, and the license management part 460 and also conducts data reception and transmission among the above parts.

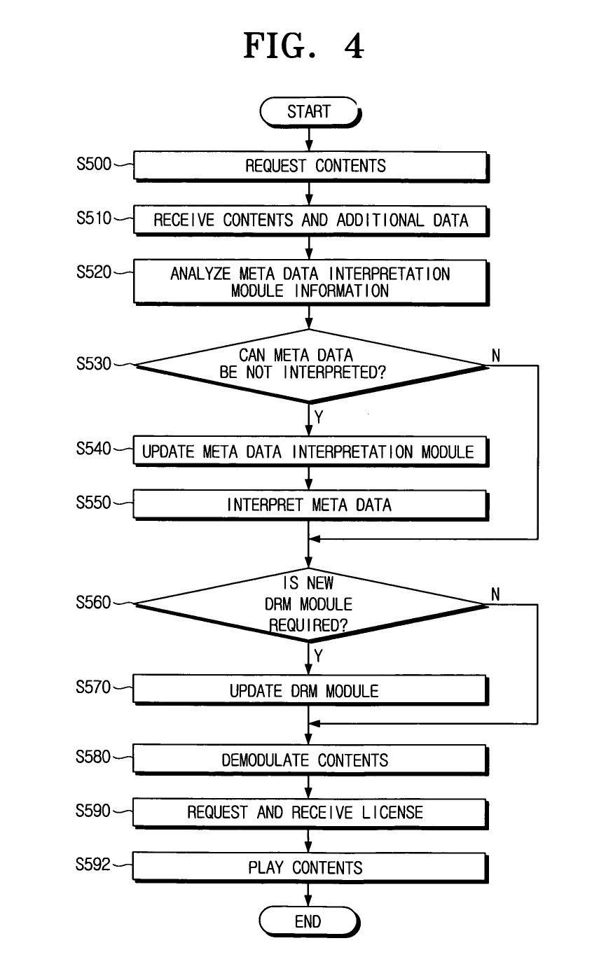

FIG. 4 is a flowchart for explaining a method for playing the contents.

Hereinafter, the method for playing the contents will be described with reference to FIGS. 2 to 4.

When the user wants to be provided with the predetermined contents, the contents player 400 requests specific contents of the contents providing server 100 through the network 300 (S500).

The contents providing server 100 being requested for the contents transmits corresponding contents and additional data, and the contents player 400 receives the contents and the additional data transmitted from the contents providing server 100. Here, the additional data includes meta data regarding the contents and the meta data interpretation module information (S510).

The contents providing server 100 analyzes the meta data interpretation module information through the meta data interpretation part 420 (S520). By the result of the analysis, it is determined whether the current meta data interpretation module is capable of interpreting the meta data (S530).

In operation S530, if the meta data cannot be interpreted, the meta data interpretation part 420 requests the meta data interpretation module of the contents providing server 100 and updates the meta data interpretation module by being provided with the meta data interpretation module from the contents providing server 100 (S540). The meta data interpretation part 420 interprets the meta data by the updated meta data interpretation module (S550).

The DRM module management part 430 determines whether there exists the DRM module for demodulating the contents through the meta data interpreted by the meta data interpretation part 420. When a new DRM module is necessitated, the DRM module management part 430 requests the DRM module of the contents providing server 100, thereby updating the DRM module (S560 and S570). Then, the DRM module management part 430 demodulates the contents by the updated DRM module (S580).

The license management part 460 requests the license of the license server 200 in order to ensure the use right for the contents and receives the requested license (S590). When the use right is ensured, the contents playing part 440 plays the contents (S592).

FIG. 5 is a block diagram of a mobile code providing device applied to the DRM system. According to FIG. 2, the contents providing server 100 comprises the meta data interpretation module database 110 and the DRM module database 120 so that the meta data interpretation module and the DRM module requested by the contents player 400 are provided by the contents providing server 100. However, this is only by way of an example; therefore, the present invention is not limited to this exemplary embodiment.

Referring to FIG. 5, supply of the meta data interpretation module and the DRM module can be performed by a mobile code providing device 600 which operates independently from the contents providing server 100.

The mobile code providing device 600 according to an exemplary embodiment of the present invention comprises a mobile code request processing part 610, a user identifying part 620, a mobile code transmission part 630, and a network interface part 640.

Additionally, the mobile code providing device 600 comprises a DRM module database 650 storing the DRM module in the mobile code form and a meta data interpretation module database 660 storing the meta data interpretation module.

When a requesting signal of the contents player 400, which is received through the network interface part 640, is a DRM module requesting signal, the mobile code request processing part 610 extracts a corresponding DRM module from the DRM module database 650. When the requesting signal of the contents player 400 is a meta data interpretation module requesting signal, the mobile code request processing part 610 extracts a corresponding meta data interpretation module from the meta data interpretation module database 660.

The user identifying part 620 checks whether the user of the contents player 400 is registered in the mobile code providing device 600 through performing a general log-in.

The mobile code transmission part 630 transmits the mobile codes of the DRM module and the meta data interpretation module that are extracted by the mobile code request processing part 610. The network interface part 640 supplies a network interface in the mobile code providing device 600.

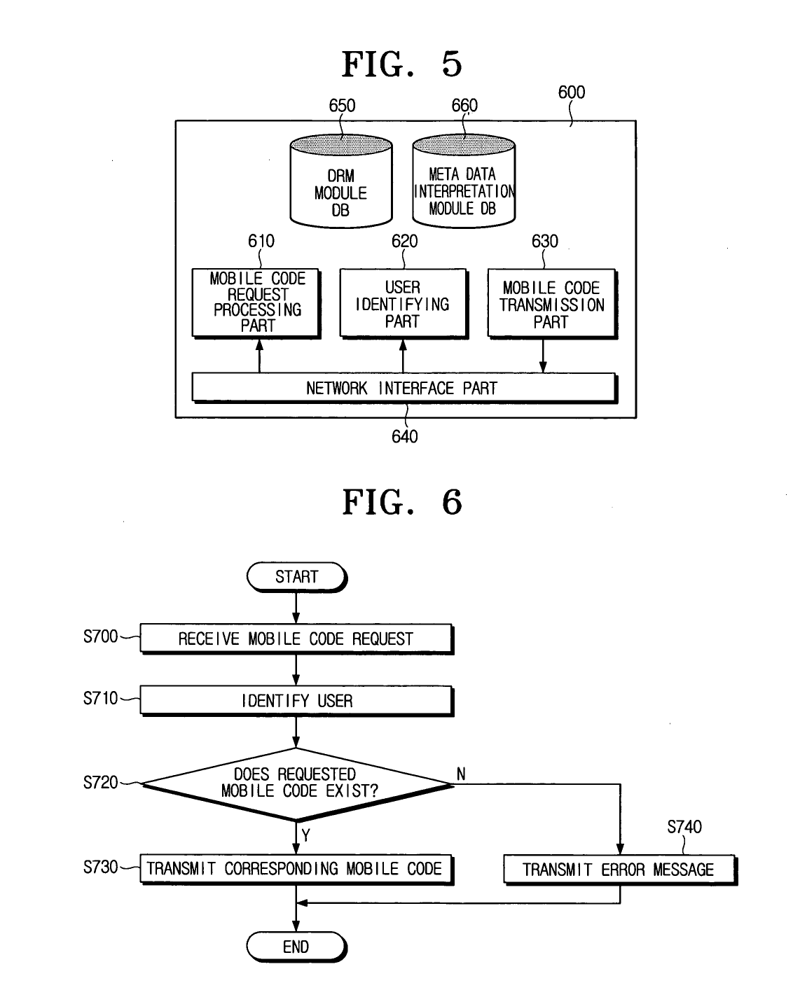

FIG. 6 is a flowchart for explaining a method for providing the mobile code. An exemplary mobile code providing method will now be described with reference to FIGS. 5 and 6.

Upon reception of a mobile code requesting signal through the network interface part 640, the user identifying part 620 identifies the user of the contents player 400 (S700 to S710).

When the user's registration is confirmed, the mobile code request processing part 610 determines whether the mobile codes of the DRM module and the meta data interpretation module, that are requested by the contents player 400, exist in the meta data interpretation module database 660 (S720).

In operation S720, when the mobile code requested by the contents player 400 exists, the mobile code request processing part 610 extracts the mobile code from the DRM module database 650 and the meta data interpretation module database 660 and transmits the extracted mobile code to the contents player 400 through the mobile code transmission part 630 (S730).

In operation S720, if the requested mobile code does not exist in the DRM module database 650 and the meta data interpretation module database 660, the mobile code request processing part 610 transmits an error message to the contents player 400 (S740).

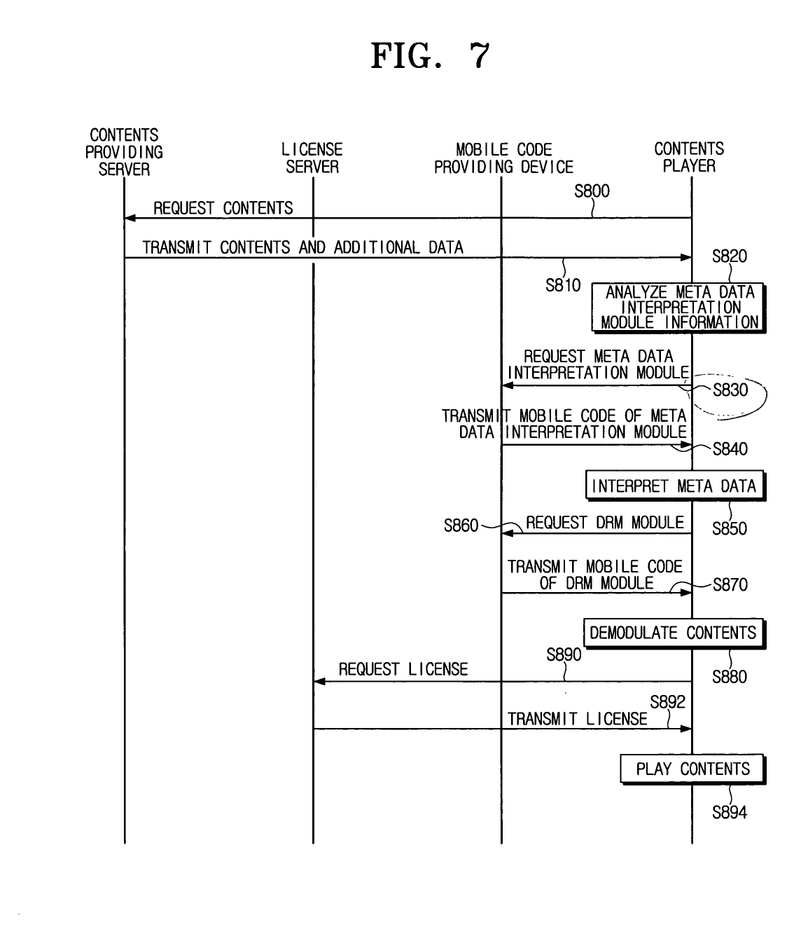

FIG. 7 is a flowchart for explaining flow of signals in the DRM system. In the present exemplary embodiment, the contents providing server 100 and the mobile code providing device 600 are separately operated.

The contents player 400 requests the necessitated contents of the contents providing server 100 (S800), and the contents providing server 100 transmits the requested contents and the corresponding additional data (S810).

The contents player 400 provided with the contents analyzes the meta data interpretation module information (S820). When unable to analyze the meta data, the contents player 400 requests the meta data interpretation module of the mobile code providing device 600 to update the meta data interpretation module (S830).

The mobile code providing device 600 being requested for the meta data interpretation module by the contents player 400 extracts the mobile code corresponding to the meta data interpretation module from the meta data interpretation module database 660 and transmits the extracted mobile code to the contents player 400 (S840).

By being provided with the mobile code from the mobile code providing device 600, the contents player 400 can update the meta data interpretation module. The contents player 400 interprets the meta data by the mobile code of the provided meta data interpretation module (S850).

Next, when the DRM module for demodulating the contents is necessitated, the contents player 400 requests the DRM module of the mobile code providing device 600 (S860). The mobile code providing device 600 requested for the DRM module extracts the corresponding mobile code from the DRM module database 650 and transmits the extracted mobile code to the contents player 400 (S870).

Being provided with the mobile code from the mobile code providing device 600, the DRM module in the contents player 400 is updated, and the contents player 400 demodulates the contents by the mobile code of the provided DRM module (S880).

The contents player 400 requests the license of the license server 200 (S890), and the license server 200 transmits the license for ensuring the right to use the contents (S892).

The contents player 400 being provided with the license and ensured with the right to use the contents plays the contents as demodulated by the DRM module (S894).

As described above, using the contents player 400 and a method for the same which are applied to the DRM system, according to an exemplary embodiment of the present invention, the DRM technology can be dynamically expanded when playing contents encrypted by the DRM technologies which are in different forms according to the type of media, and accordingly, the contents can be used and played regardless of the platform of the contents player 400 and DRM technology applied to the contents.

Furthermore, even an upgraded version of the DRM technology can be applied. Also, although the user is not informed of the DRM technology, the data relevant to the DRM technology can be updated.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A contents player applied to a digital rights management (DRM) system, the contents player comprising:
a network interface part which receives contents which are encrypted by a DRM technology and additional data regarding the contents;
a DRM module management part which demodulates the contents by a DRM module, and if the DRM module is not capable of demodulating the contents, updates the DRM module through the network interface part; and
a contents playing part which plays the contents, which are demodulated.

2. The contents player of claim 1, wherein the additional data comprises meta data of the contents and meta data interpretation module information.

3. The contents player of claim 2, wherein the meta data interpretation module information includes a uniform resource identifier which receives the DRM module.

4. The contents player of claim 2, further comprising a meta data interpretation part which analyzes the meta data by a meta data interpretation module.

5. The contents player of claim 4, wherein, if the meta data interpretation module does not correspond to the meta data, the meta data interpretation part updates the meta data interpretation module through the network interface part.

6. The contents player of claim 5, wherein the meta data interpretation module is provided in the form of a Java-based mobile code.

7. The contents player of claim 1, wherein the DRM module is provided in the form of a Java-based mobile code.

8. The contents player of claim 1, wherein the contents are received from a contents providing server.

9. The contents player of claim 8, wherein the contents providing server comprises a DRM module database which stores at least one DRM module.

10. A method for playing contents, applied to a digital rights management (DRM) system, the method comprising:
receiving contents encrypted by a DRM technology from a contents providing server and additional data regarding the contents;
demodulating the contents by a DRM module;
if the DRM module is not capable of demodulating the contents in the demodulating operation, updating the DRM module and demodulating the contents by the DRM module which is updated; and
playing the contents which have been demodulated.

11. The method of claim 10, wherein the additional data comprises meta data of the contents and meta data interpretation module information.

12. The method of claim 11, wherein the meta data interpretation module includes a uniform resource identifier which receives the DRM module.

13. The method of claim 11, further comprising analyzing the meta data by a meta data interpretation module.

14. The method of claim 13, further comprising, if the meta data interpretation module does not correspond to the meta data, updating the meta data interpretation module.

15. The method of claim 14, wherein the meta data interpretation module is provided in the form of a Java-based mobile code.

16. The method of claim 10, wherein the DRM module is provided in the form of a Java-based mobile code.

17. A mobile code providing device comprising:
a network interface part which receives a mobile code requesting signal from a contents player;
a mobile code request processing part which extracts a mobile code of a digital rights management (DRM) module and a meta data interpretation module from a database based on the requesting signal which was received; and
a mobile code transmission part which transmits the mobile code of the DRM module which is extracted and the meta data interpretation module to the contents player.

18. The mobile code providing device of claim 17, wherein the database comprises a DRM module database which stores the mobile code of the DRM module and a meta data interpretation module database which stores the mobile code of the meta data interpretation module.

19. A method for providing a mobile code to a contents player, the method comprising:
receiving a mobile code requesting signal from the contents player; and
extracting a mobile code based on the requesting signal which is received and transmitting the mobile code which is extracted to the contents player.

20. The method of claim 19, further comprising, after receiving the mobile code requesting signal, transmitting an error message to the contents player if the mobile code does not exist.
